(19) United States
(12) Patent Application Publication
(10) Pub. No.: US 2014/0269478 A1
(43) Pub. Date: Sep. 18, 2014

(54) SYSTEM, APPARATUS, AND METHOD FOR CONNECTING SHORT DISTANCE COMMUNICATION

(71) Applicant: Samsung Electronics Co., Ltd., Suwon-si (KR)

(72) Inventors: Jong-Mu CHOI, Gunpo-si (KR); Jong-Ho PARK, Anyang-si (KR); Young-Jae CHOI, Suwon-si (KR)

(73) Assignee: Samsung Electronics Co., Ltd., Suwon-si (KR)

(21) Appl. No.: 14/211,227

(22) Filed: Mar. 14, 2014

(30) Foreign Application Priority Data
Mar. 14, 2013 (KR) 10-2013-0027580

(51) Int. Cl. H04W 52/26; H04W 76/04

(52) U.S. Cl. CPC H04W 52/265; H04W 76/048
USPC 370/311; 370/329

(57) ABSTRACT

A system, an apparatus, and a method for connecting short distance communication, which recognize a sufficiently close particular terminal so as to perform a short distance communication connection with low power consumption, are provided. The system includes a server terminal which broadcasts an action frame for a proximity connection for a first predetermined time when a proximity connection function is set, and a client terminal which checks for reception of the action frame for a second predetermined time when the proximity connection function is set and performs a short distance communication connection with the server terminal when an Received Signal Strength Indicator (RSSI) value of the received action frame is equal to or greater than a threshold.

### PRIORITY

This application claims the benefit under 35 U.S.C. §119(a) of a Korean patent application filed on Mar. 14, 2013 in the Korean Intellectual Property Office and assigned Serial No. 10-2013-0027580, the entire disclosure of which is hereby incorporated by reference.

### BACKGROUND OF THE INVENTION

1. Field of the Invention

The present invention relates to a system, an apparatus, and a method for connecting short distance communication. More particularly, the present invention relates to a system, an apparatus, and a method for connecting short distance communication, which recognize a sufficiently close particular terminal having low power consumption to conveniently perform a short distance communication connection.

2. Description of the Related Art

A Wi-Fi communication connection operation using a Wi-Fi hotspot will be described. An Access Point (AP) serving as a server transmits a beacon at regular intervals, and a terminal supporting a Wi-Fi communication function identifies the AP according to a predetermined scan period or a user's scan command and performs a connection operation through an authentication process.

Further, a Wi-Fi communication connection operation between terminals using Wi-Fi Direct communication will be described. Another terminal which is in a Wi-Fi Direct on state on a screen of the terminal supporting the Wi-Fi Direct communication function is periodically found and displayed. After the corresponding terminal is selected, once an authentication process with the selected terminal is performed, an operation for connecting Wi-Fi Direct communication between two terminals is performed.

As described above, the AP serving as the server in the Wi-Fi hotspot communication or the Wi-Fi Direct communication broadcasts a beacon signal according to a predetermined period, and the terminal serving as a client receives and displays the beacon signal, which allows the user to attempt the Wi-Fi connection.

However, the process, in which the terminal serving as the server broadcasts the beacon signal according to the predetermined period and the terminal serving as the client receives and displays the beacon signal, is performed regardless of a distance between the terminal serving as the server and the terminal serving as the client. Accordingly, even when the terminal serving as the server and the terminal serving as the client are located close to each other, the connection is made with the same power consumption as that used for long distance communication.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a system, an apparatus, and a method for connecting short distance communication which recognize a sufficiently close particular terminal so as to conveniently perform a short distance communication connection with low power consumption.

Another aspect of the present invention is to provide a system, an apparatus, a method for connecting short distance communication which recognize a sufficiently close particular terminal without additional hardware to conveniently perform a short distance communication connection.

In accordance with an aspect of the present invention, a system for connecting short distance communication is provided. The system includes a server terminal which broadcasts an action frame for a proximity connection for a first predetermined time when a proximity connection function is set, and a client terminal which checks for reception of the action frame for a second predetermined time when the proximity connection function is set and performs a short distance communication connection with the server terminal when a Received Signal Strength Indicator (RSSI) value of the received action frame is equal to or greater than a threshold.

In accordance with another aspect of the present invention, an apparatus for connecting short distance communication is provided. The apparatus includes a short distance communication unit, and a controller which controls to broadcast an action frame for a proximity connection for a first predetermined time when a proximity connection function is set, connect short distance communication with a particular terminal having received the broadcasted action frame through the short distance communication unit when there is a connection request of the particular terminal, and release a setting of the proximity connection function.

In accordance with another aspect of the present invention, an apparatus for connecting short distance communication is provided. The apparatus includes a short distance communication unit, and a controller which controls to check for reception of an action frame for a proximity connection for a second predetermined time when a proximity connection function is set and connect short distance communication with a particular terminal having broadcasted the action frame through the short distance communication unit when an RSSI value of the received action frame is equal to or greater than a threshold.

In accordance with another aspect of the present invention, a method of connecting short distance communication is provided. The method includes broadcasting an action frame for a proximity connection for a first predetermined time by a server terminal when a proximity connection function is set to the server terminal, and checking for reception of the action frame for a second predetermined time by a client terminal when the proximity connection function is set to the client terminal and connecting a short distance communication with the server terminal when an RSSI value of the received action frame is equal to or greater than a threshold.

In accordance with another aspect of the present invention, a method of connecting short distance communication is provided. The method includes broadcasting an action frame for a proximity connection for a predetermined time when a proximity connection function is set, and connecting short distance communication with a particular terminal having received the broadcasted action frame when there is a connection request of the particular terminal, and releasing a setting of the proximity connection function.

In accordance with another aspect of the present invention, a method of connecting short distance communication is provided. The method includes checking for reception of an action frame for a proximity connection for a second predetermined time when a proximity connection function is set, and connecting short distance communication with a particular terminal having broadcasted the action frame when the action frame is received and an RSSI value of the received action frame is equal to or greater than a threshold.

Various embodiments of the present invention have an effect of recognizing a sufficiently close particular terminal without additional hardware to conveniently perform a short distance communication connection by providing a system, an apparatus, a method for connecting short distance communication.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a configuration of a short distance communication connection system according to an exemplary embodiment of the present invention;

FIG. 2 is a diagram illustrating a period on which a server terminal broadcasts an action frame according to an exemplary embodiment of the present invention;

FIG. 3 is a diagram illustrating a structure of an action frame according to an exemplary embodiment of the present invention;

FIG. 4 is a diagram illustrating a period on which a client terminal receives an action frame according to an exemplary embodiment of the present invention;

FIG. 5 illustrates a configuration of a short distance communication connection system according to another exemplary embodiment of the present invention;

FIG. 6 illustrates a configuration of a terminal according to an exemplary embodiment of the present invention;

FIG. 7 is a flowchart illustrating a process in which a server terminal performs a short distance communication connection according to an exemplary embodiment of the present invention; and

FIG. 8 is a flowchart illustrating a process in which a client terminal performs a short distance communication connection according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A terminal according to an exemplary embodiment of the present invention includes a portable terminal and a fixed terminal. Here, the portable terminal corresponds to an easily carried and movable electronic device, which may be a video phone, a mobile phone, a smart phone, a Wideband Code Division Multiple Access (WCDMA) terminal, a Universal Mobile Telecommunication Service (UMTS) terminal, a Personal Digital Assistant (PDA), a Portable Multimedia Player (PMP), a Digital Multimedia Broadcasting (DMB) terminal, an e-book, a portable computer (e.g., notebook, tablet Personal Computer (PC) or the like), a digital camera or the like. Further, the fixed terminal may be a desktop personal computer or the like.

Short distance communication according to an exemplary embodiment of the present invention includes Wi-Fi communication, and the Wi-Fi communication includes Wi-Fi hotspot communication and Wi-Fi Direct communication.

FIG. 1 illustrates a configuration of a short distance communication connection system according to an exemplary embodiment of the present invention and describes a Wi-Fi communication connection operation between an Access Point (AP) (i.e., server terminal) having a proximity connection function and a terminal (i.e., client).

Referring to FIG. 1, the short distance communication connection system includes an AP 200 serving as a server and terminals 100-1 to 100-n serving as clients, and each of the AP 200 and the terminals 100-1 to 100-n has the proximity connection function.

When the proximity connection function is set to the AP 200, the AP 200 broadcasts an action frame in the unit of predetermined times for a predetermined time. When a first predetermined time passes, the proximity connection function is released.

The first predetermined time for which the AP 200 broadcasts the action frame is described below with reference to FIG. 2.

FIG. 2 is a diagram illustrating a period on which a server terminal (i.e., AP) broadcasts an action frame according to an exemplary embodiment of the present invention.

Referring to FIG. 2, the AP 200 continuously broadcasts the action frame for a first predetermined time 210, for example, 2000 ms from a time when the proximity connection function is set in the unit of predetermined times 210a, for example, every 5 ms. When the first predetermined time 210 passes, the AP 200 releases the proximity connection function and does not broadcast the action frame.

Thereafter, when the proximity connection function is set again, the AP 200 broadcasts the action frame again for the first predetermined time 210 from the time when the proximity connection function is set in the unit of predetermined times 210a. When the first predetermined time 210 passes, the proximity connection function is released again.

Further, although it has been described that the action frame is broadcasted for the first predetermined time only once when the proximity connection function is set and then the proximity connection function is released in the exemplary embodiment of the present invention, the proximity connection function may be released after the action frame is periodically and repeatedly broadcasted according to a preset number of times.

A structure of the action frame broadcasted by the AP 200 for the first predetermined time according to the proximity connection function setting is as illustrated in FIG. 3.

FIG. 3 is a diagram illustrating the structure of an action frame according to an exemplary embodiment of the present invention.

Referring to FIG. 3, the action frame stores a first field 310 storing frame type information, a second field 320 storing category information, a third field 330 storing organization (e.g., company) identifier information, and a fourth field 340 storing information by which a connection with the server terminal can be made.

The first field 310 stores frame type information corresponding to “Action (0x0d)”, the second field 320 stores category information corresponding to “Vendor Specific frame (0x7f)”, and the third field 330 stores organization (e.g., company) identifier information (4 bytes).

Further, the fourth field 340 stores Service Set Identifier (SSID) (0x01), Basic Service Set Identifier (BSSID) (0x02), and channel frequency information (e.g., frequency) (0x03) as “Vendor Specific Content”.

Each of the SSID, the BSSID, and the frequency stored in the fourth field 340 has a structure of a particular frame 341. Since the fourth field 340 is a length variable field, the fourth field 340 may store additional information as well as the SSID, the BSSID, and the frequency according to the structure of the particular frame 341.

A beacon frame broadcasted by the server terminal on a predetermined period in the Wi-Fi communication stores various information including the SSID, the BSSID, and the frequency. Accordingly, the fourth field 340 of the action frame can store required information extracted from the information stored in the beacon frame as well as the SSID, the BSSID, and the frequency.

The AP 200 has the proximity connection function set thereto. The AP 200 broadcasts the action frame as illustrated in FIG. 3 for the first predetermined time 210 as illustrated in FIG. 2 and performs a short distance communication connection with one or more terminals 100-1 to 100-n having an Received Signal Strength Indicator (RSSI) value of the action frame which is equal to or greater than a threshold among terminals having received the broadcasted action frame.

When the proximity connection function is set to the terminal (e.g., terminal 100-1), reception of the action frame is checked for a second predetermined time from the time when the proximity connection function is set. When the RSSI value of the received action frame is equal to or greater than the threshold, the terminal (e.g., terminal 100-1) recognizes that the AP 200 having broadcasted the action frame is sufficiently close and performs the short distance communication connection with the AP 200 by using the action frame.

When it is assumed that the threshold is equal to or greater than a maximum RSSI value (−40 dB), if the RSSI value of the action frame broadcasted by the AP 200 is equal to or greater than the maximum RSSI value (−40 dB), it means that the AP 200 is most closely located, so that the terminal (e.g., terminal 100-1) can be directly connected with the AP 200. A connection process between the AP 200 and the terminal (e.g., terminal 100-1) are performed based on an assumption that authentication information required for the connection process is already possessed by both the AP 200 and the terminal (e.g., terminal 100-1).

The second predetermined time for which the terminal (e.g., terminal 100-1) receives the action frame will be described with reference to FIG. 4.

FIG. 4 is a diagram illustrating a period on which a client terminal receives an action frame according to an exemplary embodiment of the present invention

Referring to FIG. 4, the terminal (e.g. terminal 100-1) checks for reception of the action frame for a second predetermined time 410a from a time when the proximity connection function is set, for example, for 10 ms. When the action frame is not received for the second predetermined time 410a or an RSSI value of the received action frame is not equal to or greater than the threshold, the terminal (e.g. terminal 100-1) is switched to a sleep mode for a third predetermined time 420. Further, when the third predetermined time 420 passes, the terminal (e.g. terminal 100-1) checks again for reception of the action frame for a second predetermined time 410b, for example, 10 ms.

For the Wi-Fi connection, when searching for a particular terminal which is sufficiently close, the terminal (e.g. terminal 100-1) wakes on the predetermined period 420 and checks for the reception of the action frame only for a predetermined time so as to reduce power consumption of the terminal.

When the terminal (e.g. terminal 100-1) wakes on the predetermined period 420 to check for the reception of the action frame only for a predetermined time and the RSSI value of the received action frame is equal to or greater than the threshold, the terminal (e.g. terminal 100-1) does not perform an operation of checking for the reception of the action frame any more by releasing the proximity connection function setting.

As described above, the AP 200 and the one or more terminals 100-1 to 100-n located close to the AP 200 can recognize each other without additional hardware and conveniently perform the Wi-Fi communication connection with low power consumption.

FIG. 5 illustrates a configuration of a short distance communication connection system according to an exemplary embodiment of the present invention. Referring to FIG. 5, a Wi-Fi Direct communication connection between a first terminal 500-1 and a second terminal 500-2 which have a Wi-Fi communication unit is described.

Referring to FIG. 5, when the first terminal 500-1 serves as a server and the second terminal 500-2 serves as a client, the first terminal 500-1 performs the same operation as that of the AP 200 serving as the server in FIG. 1, and the second terminal 500-2 performs the same operation as that of one of the terminals 100-1 to 100-n serving as the client in FIG. 1.

Accordingly, the first terminal 500-1 and the second terminal 500-2 located close to the first terminal 500-1 can recognize each other and conveniently perform the Wi-Fi Direct communication connection without additional hardware.

FIG. 6 illustrates a configuration of a terminal according to an exemplary embodiment of the present invention.

Each of the terminals 100-1 to 100-n serving as the client in FIG. 1, the first terminal 500-1 serving as the server and the second terminal 500-2 serving as the client in FIG. 5 may include the same components as the terminal in FIG. 6.

Referring to FIG. 6, a Radio Frequency (RF) unit 123 performs a wireless communication function of the terminal. The RF unit 123 includes an RF transmitter for up-converting and amplifying a frequency of a transmitted signal and an RF receiver for low noise-amplifying a received signal and down-converting a frequency. A data processor 120 includes a transmitter for encoding and modulating the transmitted signal and a receiver for demodulating and decoding the received signal. That is, the data processor 120 may include a modem and a codec. Here, the codec includes a data codec for processing packet data and an audio codec for processing an audio signal such as a voice. An audio processor 125 performs a function of reproducing a received audio signal output from the audio codec of the data processor 120 or transmitting a transmitted audio signal generated from a microphone to the audio codec of the data processor 120.

A key input unit includes keys for inputting number and character information and function keys for setting various functions.

A memory 130 may include a program memory and data memories. According to programs for controlling general operations of the terminal and exemplary embodiments of the present invention, the action frame is transmitted when the proximity connection function is set to a device serving as the server, and programs for performing a control to achieve the Wi-Fi communication connection with a particular terminal broadcasting the action frame having an RSSI value equal to or greater than a threshold is stored when the proximity connection function is set to a device serving as the client. Further, the data memory performs a function of temporarily storing data generated during executions of the programs.

The controller 110 performs a function of controlling general operations of the terminal.

When the terminal serves as the server according to an exemplary embodiment of the present invention, if the Wi-Fi communication is turned on and the proximity connection function is set, the controller 110 broadcasts the action frame for the proximity connection for the first predetermined time. After broadcasting the action frame, the controller 110 releases the proximity connection function setting and performs a control such that the Wi-Fi communication connection with a particular terminal having an RSSI value of the broadcasted action frame equal to or greater than the threshold is performed through a Wi-Fi communication unit 170.

Further, when the terminal serves as the client according to an exemplary embodiment of the present invention, if the Wi-Fi communication is turned on and the proximity connection function is set, the controller 110 checks for reception of the action frame for the proximity connection for the second predetermined time. When an RSSI value of the action frame received for the second predetermined time is equal to greater than the threshold, the controller 110 recognizes a particular terminal to which the action frame is broadcasted as the particular terminal located closest to the terminal and performs a control such that the Wi-Fi communication connection with the particular terminal is performed through the Wi-Fi communication unit 170. The threshold may be a maximum RSSI value, and may be, for example, −40 dB.

At this time, when the action frame is not received until the second predetermined time passes, the controller 110 is switched to a sleep mode. When the third predetermined time passes in the sleep mode, the controller 110 wakes up and then checks again for the reception of the action frame for the second predetermined time. Alternatively, when the action frame having the RSSI value equal to or greater than the threshold is not received until the second predetermined time passes, the controller 110 is switched to the sleep mode. When the third predetermined time passes in the sleep mode, the controller 110 checks for the reception of the action frame for the second predetermined time.

Further, the controller 110 recognizes the most closely located particular terminal, and performs a control to release the proximity connection function when the controller 110 is connected with the particular terminal.

In addition, the controller 110 performs a control to inform of the proximity connection function setting when the proximity connection function setting is set according to an exemplary embodiment of the present invention, and inform of release of the proximity connection function setting when the proximity connection function setting is released.

A camera unit 140 photographs image data, and includes a camera sensor for converting a photographed optical signal to an electrical signal and a signal processor for converting a photographed analog image signal to digital data. Here, it is assumed that the camera sensor is a Charge-Coupled Device (CCD) or Complementary Metal-Oxide-Semiconductor (CMOS) sensor, and the signal processor may be implemented by a Digital Signal Processor (DSP). Further, the camera sensor and the signal processor may be implemented integrally or separately.

The image processor 150 processes Image Signal Processing (ISP) for displaying an image signal output from the camera unit 140 to a display unit 160, and the ISP performs functions such as gamma correction, interpolation, spatial change, image effect, image scale, Automatic White Balance (AWB), Automatic Exposure (AE), Automatic Focus (AF) and the like. Accordingly, the image processor 150 processes the image signal output from the camera unit 140 in the unit of frames and outputs frame image data in accordance with a characteristic and a size of the display unit 160. Further, the image processor 150 includes an image codec and performs a function of compressing the frame image data displayed on the display unit 160 through a set method or reconstructing the compressed frame image data into original frame image data. Here, the image codec may include a Joint Photographic Experts Group (JPEG) codec, a Moving Picture Experts Group 4 (MPEG4) codec, a Wavelet codec or the like. It is assumed that the image processor 150 includes an On Screen Display (OSD) function and outputs on screen display data in accordance with a display size displayed under a control of the controller 110.

The display unit 160 displays an image signal output from the image processor 150 and displays user data output from the controller 110. Here, the display unit 160 can use a Liquid Crystal Display (LCD). In this case, the display unit 160 includes an LCD controller, a memory for storing image data, and an LCD display device. When the LCD is implemented in a touch screen type, the LCD may operate as an input unit, and the display unit 160 displays keys such as the key input unit 127.

Further, when the display unit 160 is used as a touch screen unit by being implemented in the touch screen type, the touch screen unit is implemented by a Touch Screen Panel (TSP) including a plurality of sensor panels, and the plurality of sensor panels include a capacitive type sensor panel which can recognize a hand touch and an electromagnetic inductive type sensor panel which can detect a minute touch by a touch pen.

The Wi-Fi communication unit 170 performs Wi-Fi communication with the AP 200 in a Wi-Fi hotspot communication mode or performs Wi-Fi communication with another terminal having the Wi-Fi Direct communication function in a Wi-Fi Direct communication mode.

An operation of performing the Wi-Fi communication connection between the server terminal and the client terminal in the short distance communication system described above will be discussed in detail with reference to FIGS. 7 and 8.

FIG. 7 is a flowchart illustrating a process in which a server terminal performs a short distance communication connection according to an exemplary embodiment of the present invention. FIG. 7 shows a Wi-Fi communication connection operation in a server terminal side. The server terminal of FIG. 7 may be the AP 200 of FIG. 1 or the first terminal 500-1 of FIG. 5.

Hereinafter, an exemplary embodiment of the present invention will be described in detail with reference to FIG. 7 together with FIGS. 1 to 6.

Referring to FIG. 7, when the Wi-Fi communication is turned on to perform the Wi-Fi communication and the proximity connection function is set, the server terminal detects it in operation 701 and performs operation 702 in which the action frame as illustrated in FIG. 3 is broadcasted for the first predetermined time 210 in the unit of predetermined times 210 as illustrated in FIG. 2. When the proximity connection function is not set in operation 701, a corresponding function is performed.

When the first predetermined time passes while the action frame is broadcasted for the first predetermined time in the unit of predetermined times 210, the server terminal detects it in operation 703, and performs operation 704 in which the proximity connection function setting is released and thus the action frame is not broadcasted any more. When the first predetermined time does not pass while the action frame is broadcasted for the first predetermined time in the unit of predetermined times 210, the process returns to operation 702.

Thereafter, according to a Wi-Fi communication connection request of the client terminal of FIG. 8 having the RSSI value of the broadcasted action frame corresponding to the threshold, the server terminal can be automatically connected with the client terminal through the Wi-Fi communication.

FIG. 8 is a flowchart illustrating a process in which the client terminal performs the short distance communication connection according to an exemplary embodiment of the present invention. FIG. 8 shows a Wi-Fi communication connection operation in a client terminal side. The client terminal of FIG. 8 may be the terminal of FIG. 1 or the second terminal of FIG. 5.

Hereinafter, an exemplary embodiment of the present invention will be described in detail with reference to FIG. 8 together with FIGS. 1 to 6.

Referring to FIG. 8, when the Wi-Fi communication is turned on to perform the Wi-Fi communication and the proximity connection function is set, the client terminal detects it in operation 801 and performs operation 802 in which reception of the action frame as illustrated in FIG. 3 is checked for the second predetermined time 410a as illustrated in FIG. 4. When the proximity connection function is not set in operation 801, a corresponding function is performed.

When the action frame is not received for the second predetermined time 410a in operation 803, the client terminal detects it and determines whether the second predetermined time 410a passes in operation 804.

When the second predetermined time 410a does not pass, the client terminal detects it in operation 804 and returns to operation 802 in which the reception of the action frame is checked. However, when the action frame is not received until the second predetermined time 410a passes, the client terminal detects it in operation 804 and performs operation 805 in which the client terminal is switched to the sleep mode for the third predetermined time 420. When the third predetermined time 420 passes in the sleep mode, the client terminal detects it in operation 806 and returns to operation 802 in which the reception of the action frame is checked for the second predetermined time 410b.

When the action frame is received for the second predetermined time 410b, the client terminal detects it in operation 803 and performs operation 807 in which the RSSI value of the received action frame is compared with the threshold.

When the RSSI value of the received action frame is equal to or smaller than the threshold, the client terminal detects it in operation 808 and returns to operation 802 in which reception of the action frame is checked for the second predetermined time 410b.

However, when the RSSI value of the received action frame is equal to or greater than the threshold, the client terminal detects it in operation 808 and performs operation 809 in which the client terminal recognizes the server terminal having broadcasted the action frame in FIG. 7 as a most closely located server terminal and performs the Wi-Fi connection with the server terminal.

When the Wi-Fi communication between the client terminal and the server terminal is connected as the client terminal recognizes the server terminal and makes a request for the Wi-Fi communication connection to the server terminal by using information stored in the received action frame, the client terminal performs operation 810 in which the proximity connection function is released.

A system, an apparatus, and a method for connection short distance communication according to various exemplary embodiments of the present invention can be implemented as a computer readable code in a non-transitory computer readable recording medium. The non-transitory computer readable recoding medium includes all types of recording devices storing data which can be read by a computer system. For example, the non-transitory computer readable recording medium includes a Read Only Memory (ROM), a Random Access Memory (RAM), an optical disk, a magnetic tape, a floppy disk, a hard disk, a non-volatile memory and the like. Further, the non-transitory computer readable recoding medium is distributed to the computer system connected through a network, in which computer readable code may be stored and executed in a distributed manner.

While the invention has been shown and described with reference to certain exemplary embodiments thereof, it will be understood by those skilled in the art that various changes in form and details may be made therein without departing from the spirit and scope of the invention as defined by appended claims and their equivalents.

What is claimed is:

1. A system for connecting short distance communication, the system comprising:
a server terminal which broadcasts an action frame for a proximity connection for a first predetermined time when a proximity connection function is set; and
a client terminal which checks for reception of the action frame for a second predetermined time when the proximity connection function is set and performs a short distance communication connection with the server terminal when a Received Signal Strength Indicator (RSSI) value of the received action frame is equal to or greater than a threshold.

2. The system of claim 1, wherein the server terminal releases a setting of the proximity connection function when the first predetermined time passes after the action frame is broadcasted.

3. The system of claim 1, wherein the server terminal releases a setting of the proximity connection function when the short distance communication connection is performed.

4. The system of claim 1, wherein the action frame includes Service Set Identifier (SSID) information, Basic Service Set Identifier (BSSID) information, and channel information.

5. The system of claim 1, wherein the client terminal is switched to a sleep mode when the action frame is not received until the second predetermined time passes, and checks for reception of the action frame for the second predetermined time when a third predetermined time passes in the sleep mode.

6. The system of claim 1, wherein the client terminal is switched to a sleep mode when the action frame having the RSSI value equal to or greater than the threshold is not received until the second predetermined time passes and checks for reception of the action frame for the second predetermined time when a third predetermined time passes in the sleep mode.

7. The system of claim 1, wherein the client terminal releases a setting of the proximity connection function when the client terminal recognizes the server terminal which is located closest to the client terminal and then is connected with the server terminal.

8. The system of claim 1, wherein the client terminal recognizes the server terminal having broadcasted the action frame as the server terminal which is located closest to the client terminal when the RSSI value of the received action frame is equal to or greater than the threshold.

9. An apparatus for connecting short distance communication, the apparatus comprising:
a short distance communication unit; and
a controller which controls to broadcast an action frame for a proximity connection for a first predetermined time when a proximity connection function is set, connect short distance communication with a particular terminal having received the broadcasted action frame through the short distance communication unit when there is a connection request of the particular terminal, and release a setting of the proximity connection function.

10. The apparatus of claim 9, wherein the action frame includes Service Set Identifier (SSID) information, Basic Service Set Identifier (BSSID) information, and channel information.

11. The apparatus of claim 10, wherein the short distance communication unit is a Wi-Fi communication unit.

12. An apparatus for connecting short distance communication, the apparatus comprising:
a short distance communication unit; and
a controller which controls to check for reception of an action frame for a proximity connection for a second predetermined time when a proximity connection function is set and connect short distance communication with a particular terminal having broadcasted the action frame through the short distance communication unit when a Received Signal Strength Indicator (RSSI) value of the received action frame is equal to or greater than a threshold.

13. The apparatus of claim 12, wherein the controller is switched to a sleep mode when the action frame is not received until the second predetermined time passes, and checks for reception of the action frame for the second predetermined time when a third predetermined time passes in the sleep mode.

14. The apparatus of claim 12, wherein the controller is switched to a sleep mode when the action frame having the RSSI value equal to or greater than the threshold is not received until the second predetermined time passes, and checks for reception of the action frame for the second predetermined time when a third predetermined time passes in the sleep mode.

15. The apparatus of claim 12, wherein the controller controls to release the proximity connection function when the controller recognizes the particular terminal which is located closest to the controller and then is connected with the particular terminal.

16. A method of connecting short distance communication, the method comprising:
broadcasting an action frame for a proximity connection for a first predetermined time by a server terminal when a proximity connection function is set to the server terminal; and
checking for reception of the action frame for a second predetermined time by a client terminal when the proximity connection function is set to the client terminal and connecting a short distance communication with the server terminal when a Received Signal Strength Indicator (RSSI) value of the received action frame is equal to or greater than a threshold.

17. The method of claim 16, further comprising releasing a setting of the proximity connection function when the first predetermined time passes after the server terminal broadcasts the action frame.

18. The method of claim 16, wherein the server terminal releases a setting of the proximity connection function when the short distance communication is connected.

19. The method of claim 16, wherein the action frame includes Service Set Identifier (SSID) information, Basic Service Set Identifier (BSSID) information, and channel information.

20. The method of claim 16, further comprising:
switching the client terminal to a sleep mode when the action frame is not received until the second predetermined time passes; and
checking for reception of the action frame for the second predetermined time when a third predetermined time passes in the sleep mode.

21. The method of claim 16, further comprising:
switching the client terminal to a sleep mode when the action frame having the RSSI value equal to or greater than the threshold is not received until the second predetermined time passes; and
checking for reception of the action frame for the second predetermined time when a third predetermined time passes in the sleep mode.

22. The method of claim 16, further comprising releasing a setting of the proximity connection function when the client terminal recognizes the server terminal which is located closest to the client terminal and then is connected with the server terminal.

23. The method of claim 16, wherein the client terminal recognizes the server terminal having broadcasted the action frame as the server terminal which is located closest to the client terminal when the RSSI value of the received action frame is equal to or greater than the threshold.

24. A method of connecting short distance communication, the method comprising:
broadcasting an action frame for a proximity connection for a predetermined time when a proximity connection function is set; and
connecting short distance communication with a particular terminal having received the broadcasted action frame when there is a connection request of the particular terminal, and releasing a setting of the proximity connection function.

25. The method of claim 24, wherein the action frame includes Service Set Identifier (SSID) information, Basic Service Set Identifier (BSSID) information, and channel information.

26. The method of claim 24, wherein the short distance communication is Wi-Fi communication.

27. A method of connecting short distance communication, the method comprising:
checking for reception of an action frame for a proximity connection for a second predetermined time when a proximity connection function is set; and
connecting short distance communication with a particular terminal having broadcasted the action frame when the action frame is received and a Received Signal Strength Indicator (RSSI) value of the received action frame is equal to or greater than a threshold.

28. The method of claim 27, further comprising:
performing a switching to a sleep mode when the action frame is not received until the second predetermined time passes; and
checking for reception of the action frame for the second predetermined time when a third predetermined time passes in the sleep mode.

29. The method of claim 27, further comprising:
performing a switching to a sleep mode when the action frame having the RSSI value equal to or greater than the threshold is not received until the second predetermined time passes; and
checking for reception of the action frame for the second predetermined time when a third predetermined time passes in the sleep mode.

30. The method of claim 27, further comprising releasing the proximity connection function when the most closely located particular terminal is recognized and a connection with the particular terminal is made.
